(19) United States
(12) Patent Application Publication
(10) Pub. No.: US 2012/0082965 A1
(43) Pub. Date: Apr. 5, 2012

(54) "AD LITTERAM" METHOD

(76) Inventor: Alvaro J. Alves-Milho, Doral, FL (US)

(21) Appl. No.: 12/896,637

(22) Filed: Oct. 1, 2010

(51) Int. Cl. G09B 19/06

(52) U.S. Cl. 434/157; 434/167

(57) ABSTRACT

A method to teach a language may include the steps of selecting a predetermined letter sound to be evaluated, providing a first predetermined word which exhibits the predetermined letter sound, adding a first predetermined diacritic character to the first predetermined word and generating a predetermined word deleting the letters having the first predetermined diacritic character. The predetermined letter sound may be a short vowel, and the predetermined letter sound may be a long vowel. The predetermined letter sound may a long I, the predetermined letter sound may be a closed A. The predetermined letter sound may be a closed O, and the predetermined letter sound may be a vowel pronounced as a schwa. The predetermined letter sound may be the letter O, and the predetermined letter sound may be an alternate consonant. The predetermined letter sound may be a silent letter.

### FIELD OF THE INVENTION

This invention refers to a method of teaching how to read and pronounce the English language more particularly by the method of using different diacritical marks.

### BACKGROUND

Alphabetic representation of the English language is not consistent, and sometimes does not seem to follow specific criteria. This is mainly due to the evolution of English, and a lack of agreement on what sounds should be used and how to use the alphabet to represent them.

One of the main difficulties in learning to read and pronounce the English language, in particular for a non-English language speaker, is to differentiate the many vocalic sounds used in this language. Although some consonant representations are also inconsistent, they are not as numerous as vocal sound inconsistencies.

In order to better understand the problem of representing vocal sounds, it is helpful to review the origins of the alphabet.

The alphabet was the initial attempt by man to represent sounds as they were pronounced in words. It was founded on the concept of representing one sound by one symbol, and then combining them to represent different words. In this fashion, the same symbols could be reused to represent any word.

A human being is capable of producing a high number of different sounds, but it would be difficult to learn and represent all of them. By using and representing a limited number of sounds and symbols, the alphabet helped to simplify and make more accessible the task of reading and writing a language.

These symbols, called letters, were divided into two main classes:

Vowels

These are sounds created when the air flows through the throat and mouth without being interrupted. This allows for the vocal chords to vibrate and emit a sound, which is modified by the change of the relative positions of the mouth and tongue.

The basic sound created by the air passing through the vocal chords, while the mouth is in a relaxed position, is called the schwa. This sound is modified by changing the relative position of the mouth and tongue and becomes the other vowel sounds normally represented in writing. The schwa is a dull, indefinite sound, which can be easily confused with other vowel sounds. The International Phonetic Alphabet represents this sound using the symbol “ [symbol] ”.

The sound waves produced by vowel sounds are similar to musical notes, and provide the loudness of speech.

Although there are many possible vowel sounds that can be voiced, the creators of the Hebrew, Greek, and in particular the Latin alphabet chose to represent five sounds: A, E, I, O, and U (as in pat, pet, pit, long, and put). These sounds and letters represented very specific positions of the mouth which emit precise and easy to distinguish sounds.

The differences between vowel sounds can be compared to differences in the colors of the rainbow: there are actually many hues of color, but the eye easily recognizes seven colors only. Borderline graduations can be perceived as being one of these seven colors, but it may differ for each observer.

It is possible that the original five vowels sounds represented in the Latin alphabet were chosen in order to avoid the potential confusion generated by the use of the schwa. By enforcing the use of these sounds and not the schwa, the vocalic sounds were easy to differentiate and could be used to create different words, as in pat, pet, pit, pot and put.

Modern English however, uses between 18 and 24 vowel sounds, depending on the local accent of the speaker, and yet these sounds are represented only by the five vowel letters of the Latin alphabet.

This can create a lot of confusion, in particular for a foreign language speaker, who may be used to a consistent representation of sound in his own language, as in German and Italian.

Consonants

These sounds occur when there is a partial or total block of the air passing through the throat, which impedes or limits the use of the vocal chords. The sounds produced are more akin to noises than to musical sounds.

The name “consonant” means “sounds with” in Latin, and is derived from the fact that it was considered that a consonant could not be pronounced by itself, but needed a vowel sound to be uttered. In fact, vowels were considered the “souls” of words, and if we notice, as mentioned before, that a vowel provides loudness to speech, we can understand why.

The use of consonants in the English language is more consistent than the use of vowels, and is less of a problem than vowel pronunciation. The problems come when words denote a consonant which is not pronounced, as in debt, or in certain letter combinations where the consonant changes its sound, for example: combination, sure, sugar or tough.

In the ancient world, the alphabet was taught as the first step in reading, as it provided the pronunciation key to all other words. Once the alphabet was learned, it was easy to read any word, as this pronunciation key allowed to derive the sounds of all words, even if a word was never heard or seen by the reader before. This allowed for the easy and rapid expansion of the Greek and Latin cultures in the ancient world, even at a time when resources such as paper were scarce.

The Latin alphabet was not taught like the modern day English alphabet, in particular the vowels, which were taught as A (PAT), E (PET), I (PIT), O (LONG) and U (PUT).

The evolution of English has been explored in many studies, but it is interesting to note that Old English used the same principles as Latin, using the same vowel and consonant sounds.

Syllable

A syllable is composed of a combination of vowels and consonants, or a single vowel. Note that a syllable in Latin was never composed of a single consonant. Moreover, a syllable does not have a consonant in between two vowels.

Long and Short Syllables

Latin words are made by combining the basic vowel and consonant sounds. When a word had two or more syllables, one of them was usually pronounced slightly different, a difference called “accent” or “stress”.

In Latin the stressed syllable was considered to have double the duration of the non stressed syllable. Because of their nature, consonants cannot be pronounced for too long; therefore the only way to make a syllable sound longer is to extend its vowel sound. Vowels included in stressed syllables were called “long” vowels, while vowels in the other syllables were called “short”. Theoretically, a long vowel had twice the length of a short vowel but had the same sound, as the mouth was placed in the same position in both cases.

At the beginning scribes started to represent these sound variations by writing the vowel twice, or using two consonants between the vowels to make them short, and eventually arrived to the practice of using a hyphen on top of the long vowel.

Old English embraced and used the same principles used in the Latin alphabet, but eventually changed during periods called “Vowel Shifts”.

The Great Vowel Shift

According to English linguists, the English pronunciation of long vowels changed during the period called “The Great Vowel Shift”. Instead of extending or making the same vowel sounds louder as the Latin language, the stress was indicated by changing the sound.

For example, in the word “dinner”, the “I” is considered short because there are two consonants between the vowels, and is equivalent to the old Latin pronunciation. In contrast, in the word “diner”, there is only one consonant which makes the “I” long. Theoretically before the Great Vowel Shift, the long “I” in “diner” was pronounced by extending the sound of the short “I”, but after the change, it was pronounced as “dainer” (using the short sounds of “A” and “I”).

Because of the vowel changes being described here, it is very difficult to represent specific vowel sounds in English outside of a known word. Therefore when I represent vowels in italics I will be referring to the short sounds as in pat, pet, pit, long, and put.

Although most of what happened during this period is not clear, and current theories are in question, we can see that this change may have started by the use of the schwa in the pronunciation of stressed vowels.

This can be observed today in some Old English and Irish pronunciations, where diner is pronounced “dainer”. Eventually the long “I” evolved into “ai”¹ as in “dainer”.

Alternative Vowel Sounds

While Old English used the original sounds represented in the Latin alphabet, Modern English uses many vowel sounds. These sounds vary by geographic zone and make it very difficult for a foreign language student to understand the “correct” pronunciation. In many cases, the same word can have many accepted pronunciations.

Some examples of these different vowel sounds are:

Pot—in many areas of England the “o” is normally pronounced as in Latin, while in America the “o” is pronounced somewhere between an “o” and an “a”.

To—in this case the sound of the “o” is close to a short “u” (as in “put”).

These sounds will be indicated with more detail below.

Alternative Consonant Sounds

In English some consonants sounds have evolved to pronunciations that differ from the original. These variations are more regular than vowel pronunciations, and are usually part of a set combination of letters.

### EXAMPLES

Action—the syllable tion is pronounced as shon

Usual—the syllable sual is pronounced as shoal

Silent Letters

Some letters included in current words were originally pronounced but eventually stopped being pronounced. Examples: knife, debt.

### SUMMARY

A method to teach English language pronunciation may include the steps of selecting a predetermined letter sound to be evaluated, providing a first predetermined word which exhibits the predetermined letter sound, adding a first predetermined diacritic character to the first predetermined word and generating a predetermined word deleting the letters having the first predetermined diacritic character.

The predetermined letter sound may be a short vowel, and the predetermined letter sound may be a long vowel.

The predetermined letter sound may a long I, the predetermined letter sound may be a closed A.

The predetermined letter sound may be a closed O, and the predetermined letter sound may be a vowel pronounced as a schwa.

The predetermined letter sound may be the letter O, and the predetermined letter sound may be an alternate consonant.

The predetermined letter sound may be a silent letter.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a flow chart of the present invention.

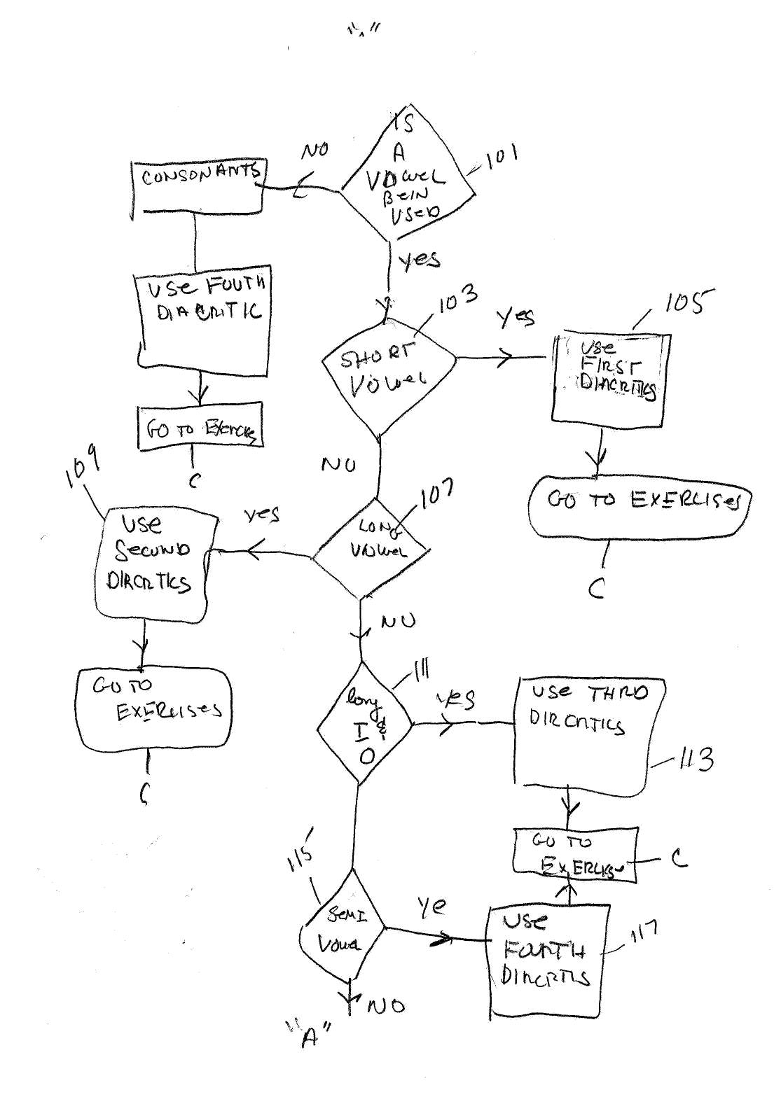

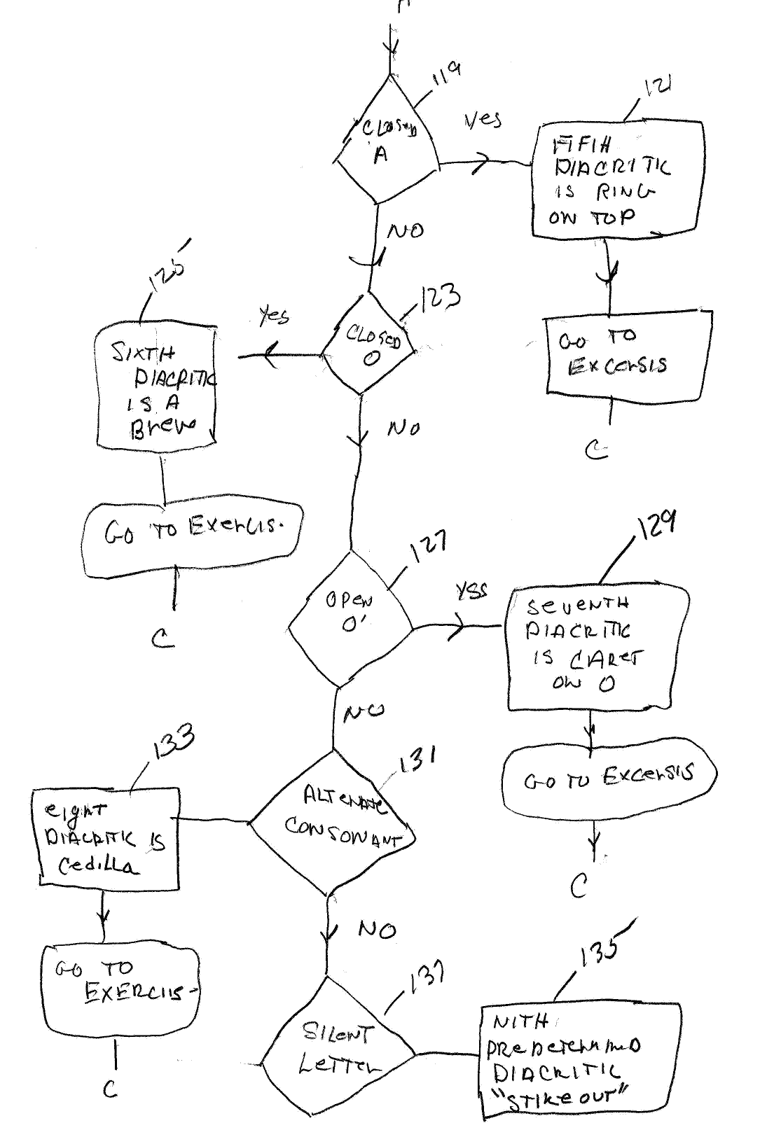

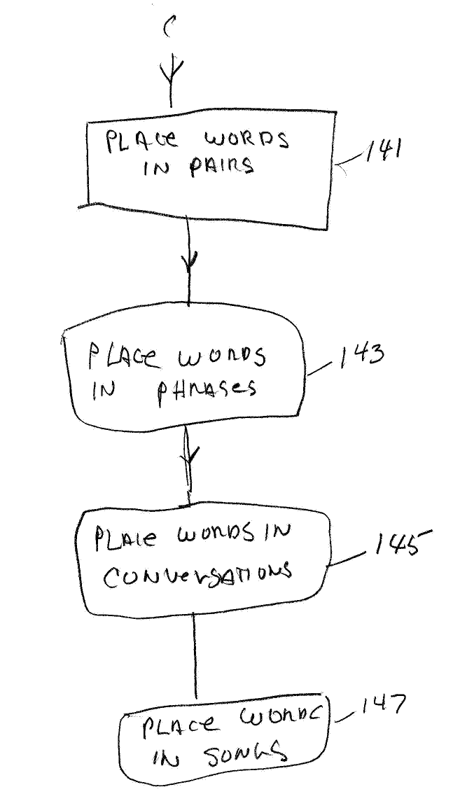

### DETAILED DESCRIPTION

The method which is the subject of this application will be called “Ad Litteram”. It uses diacritical symbols to represent the different sounds that can be represented by each letter. Unlike other existing methods, which create new symbols to represent sounds based on a particular local accent, this method keeps the original letter in the word and adds diacritic symbols to the existing letters as needed to represent the variation of the sound as a schwa, a long vowel, an alternative vowel, a modified consonant, or a silent letter.

By simplifying the number of sounds it represents, and keeping the existing words intact, it allows the reader to get used to how the current words are represented and what sounds are used. Once the student understands the concept of the different letter sounds and how they are represented in words by the use of the diacritical symbols, it is easy to go back and read the same words without diacritics, and recognize the sound variations in each of them.

Another advantage of this method is that it represents short vowels without diacritics. This is consistent with the fact that the short vowel sounds are the original sounds represented in the Latin alphabet, and are consistent with many other European languages.

By keeping the original letter and sound representations, the “Ad Litteram” method follows the traditional art of spelling, and is compatible with other languages. This is an advantage for foreign language students who are used to pronounce short vowels based on the original Latin definition, and do not have to change the way they pronounce these letters. Conversely, an English speaker who learns the original short vowel sounds unmodified, can more easily learn and read other languages.

The method includes the following steps:

Phase I—Basic Symbols and Sounds

In the first part of this course, the student is introduced to the basic concepts and symbols to be used. Each symbol is defined, with the corresponding mouth position. The actual sound is provided either by the teacher or electronically, so the sound can be identified and learned by the student. Then exercises are given to allow the student to focus on each of the sounds, including the basic positions of the mouth that are used while uttering these sounds.

1) Introduction

The basic idea of the alphabet, as explained in the “Background” section of this application, is exposed to the student. He is familiarized specifically with vowel sounds, and their relation to the schwa. The concept of the syllable and the accent are also explained.

General

The present invention identifies a predetermined letter based upon a predetermined sound and generates a modified predetermined letter based upon the predetermined sound. The modified predetermined letter may include the predetermined letter modified by a diacritic character or may include only a special diacritic character based upon the modified predetermined letter.

The different types of letters and sounds are evaluated/selected one by one List examples of words which include the predetermined letter modified by the diacritics character and based upon the predetermined sound are positioned adjacent to the same word but with the predetermined letter missing. This process continues for the entire list of words.

2) Short Vowels: A, E, I, O, U

In step 101, is a vowel being used? The first predetermined original letter is a short vowel as illustrated in step 103. Short vowels are defined one by one, providing the precise position of the mouth used while uttering each of these sounds. After each definition, examples of words (a first predetermined word) using the symbol and the corresponding sound are provided.

Exercises for each vowel are provided, by showing the word (the vowel) in one column and only the consonants and a blank space in the next column as in step 105. The first predetermined original letter and the first diacritic symbol is a blank space (predetermined word without the letters having the diacritics marked letters as illustrated in step 107. The student is supposed to write the letter and, at the same time, pronounce each word, allowing him to familiarize with the symbols and sounds being represented, and also creating a “link” in his mind between the letter and its sound.

Additionally, the symbols, sounds, and corresponding mouth positions, can be provided in electronic form.

Short A

It is pronounced by opening the mouth and placing the palate and lower jaw forming a predetermined angle in the back of the mouth. The air passing through the vocal chords produces a distinctive sound. Is the sound of A in FAT or APPLE.

Exercises:

| | |
|---|---|
| At | _t |
| Bad | B_d |
| Bat | B_t |
| Cat | C_t |
| Fat | F_t |
| Mat | M_t |
| Pat | P_t |
| Rat | R_t |
| Sat | s_t |

Short E

To pronounce this sound, the palate, and tongue are almost parallel while air passes through the vocal chords. It is the sound of E in PET or SET.

This letter is also used at the end of many words, such in tape or fate. It is always silent when used in this way, except when it is the only vowel in the word.

Exercises:

| | |
|---|---|
| Jet | J_t |
| Let | L_t |
| Met | M_t |
| Set | S_t |
| Yet | Y_t |

Short I

This sound occurs when the mouth is in a position similar to the Short E, but with the tongue almost touching the lower teeth, and the mouth a little more closed. It is the sound of I in FIT and SIT.

Exercises:

| | |
|---|---|
| Did | D_d |
| Finish | F_n_sh |
| Fish | F_sh |
| Fist | F_st |
| Fit | F_t |
| Sit | S_t |
| Hit | H_t |
| It | _t |
| List | L_st |

Short O

The short O is pronounced by forming a tunnel with the mouth, and forming a medium size circle with the lips, a shape suggested by the letter itself. It is the sound of O in AMONG and WRONG.

Exercises:

| | |
|---|---|
| Fort | F_rt |
| Long | L_ng |
| Lost | L_st |
| More | M_re |
| Or | _r |
| Order | _rder |
| Sort | S_rt |
| Soy | S_y |

Short U

This sound is pronounced with the mouth in a position similar to the O but with the lips almost closed. It is a position which is almost the inverse of the position of the short A. It is the sound of U in PUT or BUSH. This sound is also represented by the letter W, as in WATER and WINDOW.

Exercises:

| | |
|---|---|
| Bull | B_ll |
| Bush | B_sh |
| Full | F_ll |
| June | J_ne |
| Pull | P_ll |
| Push | P_sh |
| Put | P_t |
| Window | _indo_{—} |
| Water | _ater |

3) Long Vowels: Ā, Ē, Ī, Ō, Ū

The original Latin concept of a vowel being pronounced for twice the duration of a short vowel is explained, and how during the “Great Vowel Shift” the concept changed, with possible introduction of the schwa as the catalyst that made the original simple vowel sounds become the varied sound combinations represented by the long vowels today.

The second predetermined original letter is a long vowel as in step 107. Each long vowel sound is represented and explained, giving the different positions of the mouth each sound requires in order to be pronounced. The fact that the long A and the long I in particular are pronounced in different ways by English speakers is explained, giving emphasis to the American pronunciation of long vowels as perhaps the most prevalent today.

The traditional diacritic symbol to represent long vowels is the macron ( ). The second diacritics symbol is the macron ( ) as in step 109. However, because of its size, it makes it difficult to read some times. For this reason, we may also use the acute (´) accent, as it is used today in many languages to represent an accented or long vowel.

Examples and exercises for each long vowel are provided, similar to the exercises described for short vowels.

### EXAMPLES

| | |
|---|---|
| Tāpe | T_pe |
| Sēēd | S__d |
| Fīve | F_ve |
| Cōde | C_de |
| Ūse | _se |

The Schwa

It is the sound generated when air passes through the vocal chords and the mouth is in a relaxed position. It is the root of all vowels, as the different vowels are simply variations of this sound produced by the different positions of the mouth. It is considered a dull, indefinite sound. This is due to the fact that changing the mouth position, even slightly, can make the schwa sound like any of the vowel sounds. It is represented in the IPA by the symbol [symbol] . This symbol however, seems to be too close to an a or e and can create some confusion. For this method we will use the symbol Ø instead to represent the schwa.

Long Ā

The sound of the long Ā seems to come from the addition of a fast schwa before and after the short A, which merges with the A creating a gliding sound. This sound varies by region, and in America it is usually pronounced as “øAø” (as in mate).

### EXAMPLES

Lāte
Fāte
Nāme
Fāme
Sāfe
Sāme

Exercises:

| | |
|---|---|
| Āble | _ble |
| Bāse | B_se |
| Cāse | C_se |
| Cāme | C_me |
| Dāte | D_te |
| Dānger | D_nger |
| Fāce | F_ce |
| Fāme | F_me |
| Fāte | F_te |
| Fāvor | F_vor |
| Gāme | G_me |
| Lāme | L_me |

Long Ē

The long Ē is produced in the same position as the short I, but has double its duration.

### EXAMPLES

Slēēp
Dēēp
Fēēd
Grēēd
Nēēd
Kēēl
Mēēt

Exercises:

| | |
|---|---|
| Bē | B_{—} |
| Bēcause | B_cause |
| Bēfore | B_fore |
| Bēgan | B_gan |
| Bēgin | B_gin |
| Bētwēēn | B_tw_n |
| Complēte | Compl_te |
| Dēēm | D__m |
| Dēēp | D__p |
| Dēlēte | D_l_te |
| Dētect | D_tect |
| Dēvelop | D_velop |

Long Ī

The third predetermined original letter is the long Ī as in step 111. The sound of the long Ī is produced by combining the short A and short I sounds. This sound will also represented by the letter ŷ. The third diacritics is by the letter ŷ as in step 113.

### EXAMPLES

Tīme
Crīme
Fīne
Shīne
Līme
Fīght
Rīght
Flŷ

Exercises:

| | |
|---|---|
| Advertīse | Advert_se |
| Crīme | Cr_me |
| Crŷ | Cr_{—} |
| Fīght | F_ght |
| Fīnd | F_nd |
| Flŷ | Fl_{—} |
| Īce | _ce |
| Julŷ | Jul_{—} |
| Kīte | K_te |
| Līght | L_ght |
| Mīght | M_ght |
| Mīght | M_ght |

Long Ō

The sound of the long Ō is a created by placing the mouth initially in the position of the short O, and then reducing the circle of the lips, emitting a sound that is close to a short U but softer.

### EXAMPLES

Vōte
Whōle
Wrōte
Hōle
Mōle

Exercises:

| | |
|---|---|
| Vōte | V_te |
| Whōle | Wh_le |
| Wrōte | Wr_te |
| Hōle | H_le |
| Mōle | M_le |
| Nōte | N_te |
| Phōne | Ph_ne |
| Zōne | Z_ne |
| Tōne | T_ne |

Long Ū

The long Ū is a combination of the sound of the schwa and the short U: øU.

### EXAMPLES

Flūte
Mūte
Tūne
Cūte
Mūle

Exercises:

| | |
|---|---|
| Cūte | C _ te |
| Eūrope | E _ rope |
| Excūse | Exc _ se |
| Flūte | Fl _ te |
| Fūse | F _ se |
| MūIe | M _ le |
| Mūte | M _ te |
| Refūse | Ref _ se |
| Tūne | T _ ne |
| Ūnity | _ nity |
| Ūniversal | _ niversal |

4) Vowels Pronounced as Schwa

The fourth predetermined original letter is the schwa semi-vowel as illustrated in step 115. Many vowels have lost their original sounds and are pronounced as a schwa, especially when they are close to a semivowel.

Semivowels are defined as consonants which by their nature imply the brief pronunciation of the schwa, in particular in the case of “R” and “L”.

In many cases, in particular when the “R” is involved, the schwa in the semivowel takes precedence over the vowel sound, which is then simply pronounced as a scwha.

The fourth original letter diacritic is the dieresis in top as in step 117. These cases will be represented by using the dieresis in top: ä, ë, ï, ö, ü, \ddot{w}

### EXAMPLES

| | |
|---|---|
| Bïrd | B _ rd |
| Absürd | Abs _ rd |
| Cäre | C _ re |
| Ans\ddot{w}ër | Ans _ _ r |

5) Alternative Vowel Sounds

The following alternative sounds are defined:

The fifth predetermined original letter is the closed A as in step 119. The “closed A”, represented by Å, using the ring on top of the A. The fifth original letter diacritic is the ring on the top as in step 121.

This sound is produced by placing the mouth in the position of the short A but forming a circle with the lips. It produces a sound that is a mix of the short A and the short O. The use of the ring on top of the Å reminds us that it the “A” is pronounced close to an “O”.

### EXAMPLES

Måll
Fåll
Åll

Exercises:

| | |
|---|---|
| Ålternāte | _ lternāte |
| Ålthough | _ lthough |
| Cåll | C _ ll |
| Fåll | F _ ll |
| MålI | M _ ll |
| TåII | T _ ll |
| Wår | W _ r |

The sixth predetermined original letter is the closed O as in step 123, and the sixth predetermined diacritic is the breve on top as in step 125. The “closed O”, represented by \check{O}, with the breve on top of the O.

The mouth is placed in the same position as the short O but the lips are more closed, producing a sound similar to a short U but softer. The breve on top of the “\check{O}” reminds us it pronounced close to a short “U”.

Examples
D\check{o}
D\check{o}\check{o}m
F\check{o}\check{o}d
G\check{o}\check{o}d
R\check{o}\check{o}m
S\check{o}\check{o}n

Exercises:

| | |
|---|---|
| D\check{o} | D _{—} |
| D\check{o}\check{o}m | D _ _ m |
| F\check{o}\check{o}d | F _ _ d |
| G\check{o}\check{o}d | G _ _ d |
| R\check{o}\check{o}m | R _ _ m |
| S\check{o}\check{o}n | S _ _ n |

The seventh predetermined original letter is the “open” O as in step 127, and the seventh diacritic is the caret on top as in step 129. The “open O”, represented by Ô, using the caret on top of the O.

This is very similar to the “closed A”, but has a tendency to be pronounced more like a short A. The caret on top of the “Ô” reminds us it is pronounced close to a short “A”.

### EXAMPLES

Bôund
Fôund
Grôund
ôut
Rôund
Sôund

Exercises:

| | |
|---|---|
| Bôund | B _ und |
| Dôck | D _ ck |
| Fôund | F _ und |
| Fôx | F _ x |
| Grôund | Gr _ und |
| Môck | M _ ck |
| Môp | M _ p |
| Nôt | N _ t |
| Ôut | _ ut |

The “open U”, represented by Û, putting the caret on top of the U.

This is basically a schwa where the mouth is a little more open creating a sound very close to a dull short “A”. The caret on top of the “Û” reminds us it is pronounced close to a short “A”

### EXAMPLES

Bût
Cût
Rût
Shût
Ûntil

Exercises

| | |
|---|---|
| Bût | B _ t |
| Cût | C _ t |
| Rût | R _ t |
| Shût | Sh _ t |
| Ûntil | _ ntil |
| Ûnderstand | _ nderstand |
| Sûn | S _ n |
| Sûccess | S _ ccess |

The O pronounced as UA, such as in once, is represented by using the tilde on top: õnce.

6) Alternative Consonants

The eighth predetermined original letter is the alternate consonants as in step 131, and the eighth predetermined diacritic is the cedilla as in step 133. The “sh” sound used mostly in syllables such as tion in caution, and su in sugar, will be represented with a cedilla.

### EXAMPLES

| | |
|---|---|
| Cåü [symbol] ion | Cåü _ ion |
| [symbol] ūgar | _ ūgar |
| [symbol] hance | _{——} ance |

7) Silent Letters

The ninth predetermined original letter is a silent letter as in step 137, and the ninth predetermined diacritic is striking the letters out as in step 135. Silent letters will be represented by striking them.

### EXAMPLES

| | |
|---|---|
| [symbol] nīfe | _ nīfe |
| De [symbol] t | De _ t |

7) Digraphs

A digraph is composed of two vowels put together to represent a sound that is different than the original sound represented by each vowel. The original idea was to represent the alternative sounds by using these vowel combinations. Unfortunately the use of digraphs was never standardized, and many digraphs represent more than one sound.

For example in the word tough, the ou represents the sound of Ō, in sound it is ÔU, in though it is simply OU, and in wound it is \check{O}U. By noticing that the actual sounds represented by the digraphs are the same sounds described in sections 3 and 5, we will be able to use these same symbols to differentiate them. When a vowel is mute as the U in tough, we will use the dieresis on top of the vowel.

### EXAMPLES

| | |
|---|---|
| Tôügh | T _ ügh |
| Sôund | S _ und |
| Though | Th _ _ gh |
| W\check{o}und | W _ und |

The main digraphs are:
Short EÄ—in this case the E is short and the A is not pronounced.

There are only a few cases of this.

Examples
Teär
Beär
Reäd

Exercises:

| | |
|---|---|
| Teär | T _ _ r |
| Beär | B _ _ r |
| Reäd | R _ _ d |

Long ĒÄ—in this case the Ē is long and the Ä is not pronounced.

Examples:
Dēär
Ēäch
Ēägle

Exercises:

| | |
|---|---|
| Dēär | D _ ar |
| Ēäch | _ ach |
| Ēägle | _ agle |
| Ēär | _ ar |
| Fēär | F _ ar |
| Hēär | H _ ar |

ÅÜ—the Å is pronounced and the Ü is not. It is also represented as ÅW.

Examples:
Åuto
Fåwn
Låwn
ÅwkwÅrd

Exercises:

| | |
|---|---|
| Åuto | _ uto |
| Fåwn | F _ wn |
| Låwn | L _ wn |
| åwkwård | _ wkw _ rd |
| dåwn | d _ wn |
| påuse | p _ use |
| åunt | _ unt |
| håunt | h _ unt |

ÄI—the Ä is pronounced as a schwa, and the I is pronounced very slightly. Some speakers do not even pronounce the “I”.

### EXAMPLES

Agäin
Äir
Chäir
Fäir

Exercises:

| | |
|---|---|
| Agäin | Ag _ in |
| Äir | _ ir |
| Chäir | Ch _ ir |
| Fäir | F _ ir |
| Räin | R _ in |
| Säint | S _ int |
| Fäint | F _ int |

ĒĒ—it has the same pronunciation as the long Ē.

### EXAMPLES

Dēēd
Fēēt
Kēēl
Nēēd
Rēēd

Exercises:

| | |
|---|---|
| Dēēd | D _ _ d |
| Fēēt | F _ _ t |
| Kēēl | K _ _ l |
| Nēēd | N _ _ d |
| Rēēd | R _ _ d |
| Sēēd | S _ _ d |

Exception Words

Some words do not follow any of the guidelines. In many cases because they come from a different language, or because they had two pronunciations and spellings in old English which were consolidated. These words will be listed for memorization.

### EXAMPLES

| | |
|---|---|
| Sew | Sow |
| Colonel | Kernel |
| Buffet | Buffei |

The first exercise is to place the modified words with the modified letters adjacent to the word without the modified letters as in step 141.

Phase II

Once the student is familiarized with the different basic sounds and symbols, he is ready to start applying them in phrases in step 143.

The exercises provided in this section are composed of phrases written using the diacritical marks. The phrase is then written with spaces where the special characters are supposed to be written so the student can u the right characters.

### EXAMPLES

Thë hôuse is grēēn

Th_ h_use is gr_{——}n

Can y\check{o}u show mē thë hôuse?

Can y_u show m_ th_ h_use

Phase III

Now we provide more complex examples of conversations in step 145 using the diacritical symbols and letting the student read the phrase with the symbols first and then without them. This allows the student to get used to the normal English representation of words.

### EXAMPLES

Hellō, mŷ nāme is John. I am an enginēēr and Ī work for the Côunty Manägëment Ôffice.

Hello, my name is John. I am an engineer and I work for the County Management Office.

Phase IV

A) We use the diacritics in lyrics so the student can practice by singing in step 147 along to get more proficient with pronunciation.

### EXAMPLES

Can't bûy mē love, love, can't bûy mē love

I'll bûy yôu a dīamond ring mŷ frïend

If it mākes y\check{o}u fēēl åll rīght

Cåüse Ī dōn't cäre t\check{o}\check{o}

mûch for mônēy

For môney can't bûy mē love

B) We provide the same lyrics without special characters, so the student can now see the words as they are represented normally in English.

Can't buy me love, love, can't buy me love . . .

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method to teach a language, comprising:
selecting a predetermined letter sound to be evaluated;
providing a first predetermined word which exhibits the predetermined letter sound;
adding a first predetermined diacritic character to the first predetermined word;
generating a predetermined word deleting the letters having the first predetermined diacritic character.

2) A method to teach a language as in claim 1, wherein predetermined letter sound is a short vowel.

3) A method to teach a language as in claim 1, wherein the predetermined letter sound is a long vowel.

4) A method to teach a language as in claim 1, wherein the predetermined letter sound is a long I.

5) A method to teach a language as in claim 1, wherein the predetermined letter sound is a closed A.

6) A method to teach a language as in claim 1, wherein the predetermined letter sound is a closed O.

7) A method to teach a language as in claim 1, wherein the predetermined letter sound is a vowel pronounced as a schwa.

8) A method to teach a language as in claim 1, wherein the predetermined letter sound is the letter O.

9) A method to teach a language as in claim 1, wherein the predetermined letter sound is an alternate consonant.

10) A method to teach a language as in claim 1, wherein the predetermined letter sound is a silent letter.
